(19) United States
(12) Patent Application Publication
(10) Pub. No.: US 2020/0182700 A1
(43) Pub. Date: Jun. 11, 2020

(54) MEASURING PROBE HEAD

(71) Applicant: Siemens Aktiengesellschaft, Muich (DE)

(72) Inventors: Lena Farahbod-Sternahl, Hannover (HA); Christoph Kiener, München (DE); Thomas Klemke, Berlin (DE); Ivo Krausz, Berlin (DE); Daniel Reznik, Berlin (DE); Alexandr Sadovoy, Berlin (DE); Frank Schulz, Berlin (DE); Rene Seifert, Falkensee (DE); Rüstü Söl, Berlin (DE); Angelo Rudolphi, Berlin (DE)

(73) Assignee: Siemens Aktiengesellschaft, Munich (DE)

(21) Appl. No.: 16/611,014

(22) PCT Filed: May 18, 2018
(86) PCT No.: PCT/EP2018/063037

§ 371 Date: Nov. 5, 2019

(30) Foreign Application Priority Data
May 22, 2017 (DE) 10 2017 208 645.9

(51) Int. Cl. G01J 5/04; G01K 7/02; G01J 5/06; G01J 5/00

(52) U.S. Cl. CPC G01J 5/042; G01K 7/02; G01J 2005/0077; G01J 5/0088; G01J 5/061

(57) ABSTRACT

A measuring probe head having a housing, which defines a receiving space and at least one coolant fluid supply channel fluidically connected thereto, and at least one sensor which is received, or is capable of being received, in the receiving space, wherein at least one partial region of the housing enclosing the receiving space has a porosity which defines a plurality of coolant fluid passage openings.

### CROSS REFERENCE TO RELATED APPLICATIONS

This application is the US National Stage of International Application No. PCT/EP2018/063037 filed 18 May 2018, and claims the benefit thereof. The International Application claims the benefit of German Application No. DE 10 2017 208 645.9 filed 22 May 2017. All of the applications are incorporated by reference herein in their entirety.

### FIELD OF INVENTION

The present invention relates to a measuring-probe head having a housing, which defines an accommodating space and at least one cooling-fluid feed channel fluidically connected thereto, and having at least one sensor, which is or can be accommodated in the accommodating space. The sensor can be basically any sensor which can sense measured values, for example a thermocouple for sensing measured temperature values or an image sensor for capturing images, it being possible for the latter to be two-dimensional images in the UV, visible or also infrared range. Similarly, it is also possible to provide a plurality of image sensors which supply data from which three-dimensional images can be generated.

### BACKGROUND OF INVENTION

An extremely wide variety of different configurations of measuring-probe heads of the type mentioned in the introduction are known in the prior art. For the purpose of sensing measured values in environments at high temperatures, such as, in particular, within furnaces or combustion chambers, said measuring-probe heads have to be appropriately temperature-resistant. It is a known possibility to use sensors designed specifically for the high temperatures, for example high-temperature thermocouples. As an alternative, or in addition, sensors are subjected to laborious and cost-intensive cooling, e.g. image sensors which are used for flame-observation purposes. Yet another alternative consists in using sensors in operating conditions beyond those envisaged for them, although this results, following a certain period of time, in distorted measured values being sensed and/or in the corresponding sensor failing. A further problem of using measuring-probe heads in furnaces or combustion chambers is that the measuring environment is often permeated with dust and particles, which can lead to the sensor used becoming dirty. It is also the case here that the measured values sensed by the sensors can be distorted. In addition, the sensor can fail if it becomes dirty.

In order to ensure that, despite the adverse conditions, the sensors used in furnaces and combustion chambers sense comparatively reliable measured values, it is common practice to use measuring-probe heads on a redundant basis, and therefore the measured values sensed by the respective sensors can be compared with one another in order for a damaged sensor to be identified. Furthermore, redundant sensors can take over the task of a damaged or failed sensor. Maintenance and servicing cycles can be extended in this way. A disadvantage of using measuring-probe heads on a redundant basis, however, is the high costs involved.

### SUMMARY OF INVENTION

Proceeding from this prior art, it is an object of the present invention to create a measuring-probe head of the type mentioned in the introduction with an alternative construction, which at least partially remedies the abovedescribed problems in respect of use in high-temperature environments.

In order to achieve this object, the present invention creates a measuring-probe head of the type mentioned in the introduction which is characterized in that at least one sub-region which forms part of the housing and encloses the accommodating space has a porosity which defines a multiplicity of cooling-fluid through-passage openings. This construction makes it possible for the sensor, which is arranged in the accommodating space, to be cooled via a cooling fluid, which is fed through the cooling-fluid feed channel and then leaves the housing through the cooling-fluid through-passage openings. At the same time, when use is made of the measuring-probe head according to the invention in a turbomachine flow channel, through which a high-temperature working medium flows, for example when use is made of said measuring-probe head in a combustion chamber of a gas turbine, effective effusion cooling of the sensor head, and thus of the sensor, is provided.

The porosity-containing sub-region of the housing is formed advantageously by a three-dimensional lattice structure. A three-dimensional lattice structure is understood here to mean a structure in which crossover lattice crosspieces not only define a planar or curved surface, as is the case for example in a planar or curved perforated sheet, but also extend in a third dimension, this resulting in the formation, between the lattice crosspieces, of interconnected three-dimensional lattice-cavity cells which are in the form of cuboids, pyramids or the like and define the cooling-fluid through-passage openings.

It is advantageously the case that at least the porosity-containing sub-region of the housing is produced from a metallic material, for example alloys of titanium or aluminum, nickel-based or cobalt-based alloys or the like, which have good temperature resistance. It is also possible for the entire housing to be produced from one metal alloy or from different metal alloys.

It is advantageously the case that at least the porosity-containing sub-region of the housing is produced by additive manufacturing. The three-dimensional lattice structure can be produced by additive manufacturing, for example using an SLM process (Selective Laser Melting).

According to one configuration of the present invention, the housing has at least two housing parts, which are connected to one another in particular in a releasable manner and of which one housing part forms the porous sub-region. A releasable connection between the housing parts is advantageous to the extent that the sensor, which is or can be accommodated in the accommodating space, can be changed over without the housing being damaged. It is thus possible for the housing parts to be provided, for example, with an internal thread and a matching external thread and to be screw-connected to one another or to be connected to one another via a bayonet closure and/or screws, etc., to name but a few examples.

The pores advantageously have a pore size ranging from 50 μm to 3 mm, advantageously ranging from 50 μm to 1.5 mm, and even better ranging from 250 μm to 750 μm.

According to one configuration of the present invention, cables of the at least one sensor are guided through the at least one cooling-fluid feed channel. Accordingly, there is no need for the housing to be provided with separate cable channels.

The present invention also creates a measuring method in which a measuring-probe head according to the invention, for the purpose of sensing at least one measured value, is arranged in a region of a turbomachine, which has a working medium flowing through it, wherein a cooling fluid is introduced through the cooling-fluid feed channel of the housing. The introduction of the cooling fluid takes place advantageously continuously during operation of the turbomachine. In dependence on the type of sensor of the measuring-probe head, said introduction of cooling fluid can be interrupted at a predetermined time interval before a measurement is carried out and can restart in particular immediately after the measurement has been carried out, if the temperature within the accommodating space has to assume ambient temperature in order for a measurement to be carried out, for example in the case of a temperature measurement.

During normal operation, the working medium has, in particular, a temperature of at least 1000° C., advantageously a temperature of at least 1400° C., since the advantages which go hand in hand with the measuring-probe head according to the invention are exploited particularly well at such temperatures.

### BRIEF DESCRIPTION OF THE DRAWINGS

Further features and advantages of the present invention will become clear with reference to the following description of a measuring-probe head according to an embodiment of the present invention, with reference being made to the accompanying drawing, in which:

FIG. 1 shows a schematic sectional view of a measuring-probe head according to an embodiment of the present invention;

FIG. 2 shows an enlarged view of the detail which is denoted by reference sign II in FIG. 1 and shows a wall of a sub-region of a housing of the measuring head illustrated in FIG. 1;

FIG. 3 shows a sectional view through the wall, the section being taken along line III-III in FIG. 2;

FIG. 4 shows an enlarged view of the detail which is denoted by reference sign IV in FIG. 2; and

FIG. 5 shows an enlarged view of the detail which is denoted by reference sign V in FIG. 3.

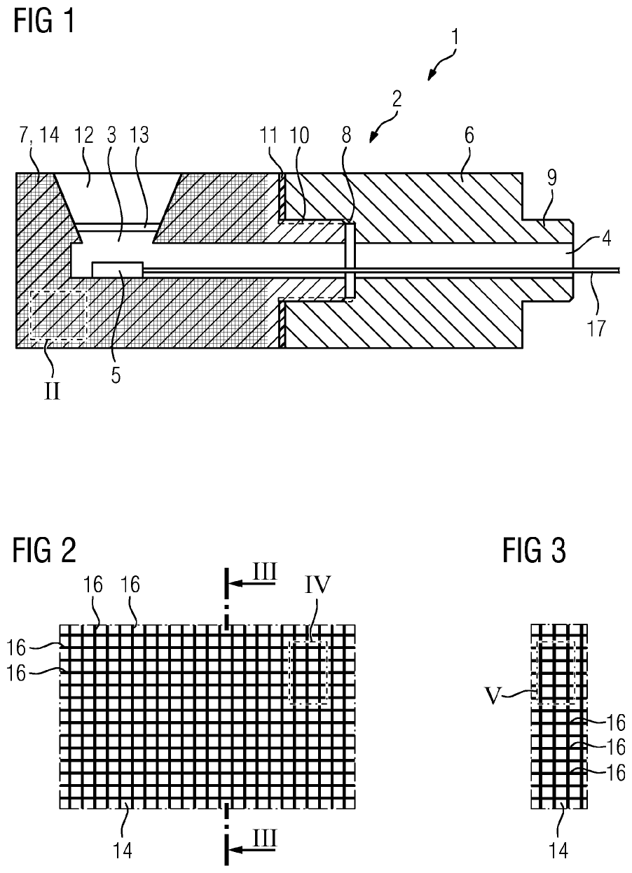

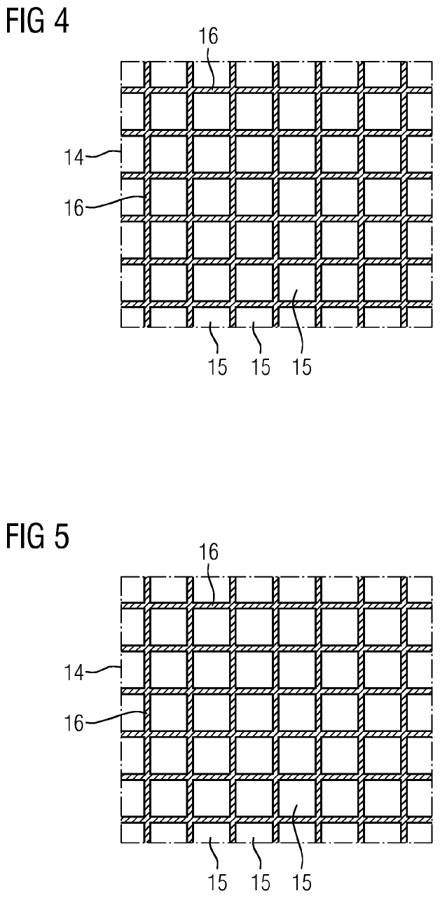

### DETAILED DESCRIPTION OF INVENTION

The measuring-probe head 1 comprises an in this case cylindrical housing 2, which defines an accommodating space 3 and at least one cooling-fluid feed channel 4 fluidically connected thereto, and also comprises a sensor 5, which is or can be accommodated in the accommodating space 3.

The housing 2 is subdivided in the axial direction into two housing parts 6 and 7, which are fastened on one another in a releasable manner, in this case are screw-connected to one another.

The first housing part 6 is produced in the form of a solid metal body and, on its end side which is directed toward the second housing part 7, has a central threaded bore 8. A connection 9 for a cooling-fluid line (not illustrated specifically) is formed, likewise in the center, on the opposite end side of the first housing part 6, wherein the cooling-fluid feed channel 4 extends centrally through the connection 9 and opens out centrally into the threaded bore 8.

On its end side which is directed toward the first housing part 6, the second housing part 7 comprises a threaded protrusion 10, which is assigned to the threaded bore 8 and is screwed into the threaded bore 8, wherein a sealing ring 11 is positioned between the two housing parts 6 and 7. The cooling-fluid feed channel continues centrally through the threaded protrusion 10 and opens out into the accommodating space 3, which is formed in the second housing part 7. An opening 12 is formed in the second housing part, above the sensor 5, which is positioned in the accommodating space 3, said opening connecting the accommodating space 3 to the surroundings and tapering conically in the direction of the accommodating space 3, wherein the opening 12 is closed by a transparent plate 13. It is also the case here that the second housing part 7 is produced from metal, wherein a sub-region 14 which forms part of the second housing part 7 and encloses the accommodating space 3 has a porosity which defines a multiplicity of cooling-fluid through-passage openings 15. In more specific terms, the porosity-containing sub-region 14 is designed, by means of additive manufacturing, in the form of a three-dimensional lattice structure which comprises a multiplicity of lattice crosspieces 16, which in this case define fluid through-passage openings 15, which generate a porosity ranging from 50 μm to 3 mm, advantageously ranging from 50 μm to 1.5 mm, and even better ranging from 250 μm to 750 μm.

The sensor 5 here is an image sensor which is oriented in the direction of the opening 12 of the second housing part 7 and of which the cables 17 are guided through the cooling-fluid feed channel 4. It should be pointed out however that, as an alternative, the sensor 5 used can also be in the form of thermocouples or other types of sensor, and that, depending on the type of sensor used, the opening 12 can be dispensed with.

In order to carry out a measuring method according to an embodiment of the present invention, the measuring-probe head is positioned in a suitable manner in a region of a turbomachine which has a working medium flowing through it, for example in the region of a combustion chamber, for flame-observation purposes, within which the temperature of the working medium is between 1400 and 1600° C. A cooling fluid is introduced continuously through the cooling-fluid feed channel 4 of the housing 2, said cooling fluid cooling the sensor 5 and then leaving the housing 2 in the direction of the combustion chamber through the cooling-fluid through-passage openings 15. The cooling fluid flowing into the combustion chamber is redirected to the exit of the combustion chamber by the working medium flowing through the combustion chamber, wherein a cooling film forms between the housing 2 of the measuring-probe head 1 and the working gas. The cooling film adsorbs heat and removes the same in the flow direction. This gives rise to very effective and inexpensive cooling which provides permanent protection to the sensor 5 used, ensures that reliable measured values are sensed and allows the use of inexpensive sensors 5.

For the case where the sensor 5 is a temperature sensor, it may be necessary for the feed of cooling fluid to be interrupted briefly in order for a measurement to be carried out, this making it possible for the accommodating space 3 to heat up briefly to ambient temperature, which is then sensed by the sensor 5. If the surroundings are at a temperature which the sensor 5 can withstand over a certain period of time, then the cooling, which is restarted after the measurement has been carried out, allows the sensor to have a long service life. However, even for the case where the sensor 5 can only be used once, on account of the ambient temperature being too high, the construction of the measuring-probe head 1 according to the invention is advantageous to the extent that the cooling makes it possible for the point in time at which measuring takes place to be selected freely.

Although the invention has been specifically illustrated and described in detail by way of the exemplary embodiment, the invention is not restricted by the examples disclosed, and a person skilled in the art can deduce other variations therefrom without departing from the scope of protection of the invention. In particular, the shape of the housing is variable. It is also possible for the latter to be formed in one part or to be made up of more than two housing parts. A releasable connection between housing parts can also take place in some other way. A releasable connection is desirable, but not imperative, to provide for straightforward changeover of the sensor or of the sensors. The three-dimensional lattice structure can assume any desired shape in order to realize the desired number and size of cooling-fluid through-passage openings. The material or the materials from which the housing is produced is or are advantageously high-temperature-resistant metal alloys, but other materials are also possible, for example ceramics, to name but one example. The material of the porous sub-region of the housing should be capable of being produced by additive manufacturing.

1.-9. (canceled)

10. A measuring-probe head, comprising:
a housing, which defines an accommodating space and at least one cooling-fluid feed channel fluidically connected thereto, and
at least one sensor, which is or can be accommodated in the accommodating space,
wherein at least one sub-region which forms part of the housing, and encloses the accommodating space, has a porosity which defines a multiplicity of cooling-fluid through-passage openings, wherein the porosity-containing sub-region of the housing is produced by additive manufacturing.

11. The measuring-probe head as claimed in claim 10,
wherein the porosity of the sub-region of the housing is formed by a three-dimensional lattice structure.

12. The measuring-probe head as claimed in claim 10,
wherein at least the porosity-containing sub-region of the housing is produced from a metallic material.

13. The measuring-probe head as claimed in claim 10,
wherein the housing has at least two housing parts, which are connected to one another and of which one housing part forms the porosity-containing sub-region.

14. The measuring-probe head as claimed in claim 10,
wherein the pores have a pore size ranging from 50 μm to 3 mm.

15. The measuring-probe head as claimed in claim 10,
wherein cables of the at least one sensor are guided through the at least one cooling-fluid feed channel.

16. A measuring method for sensing at least one measured value, comprising:
arranging the measuring-probe head as claimed in claim 10 in a region of a turbomachine which has a working medium flowing through it;
introducing a cooling fluid through the cooling-fluid feed channel of the housing; and
sensing at least one measured value by the measuring-probe head.

17. The measuring method as claimed in claim 16,
wherein, during normal operation, the working medium has a temperature of at least 1000° C.

18. The measuring method as claimed in claim 16,
wherein, during normal operation, the working medium has a temperature of at least 1400° C.

19. The measuring-probe head as claimed in claim 13,
wherein the two housing parts are connected to one another in a releasable manner.

20. The measuring-probe head as claimed in claim 14,
wherein the pores have a pore size ranging from 50 μm to 1.5 mm.

21. The measuring-probe head as claimed in claim 14,
wherein the pores have a pore size ranging from 250 μm to 750 μm.
